(19) United States
(12) Patent Application Publication
(10) Pub. No.: US 2004/0141629 A1
(43) Pub. Date: Jul. 22, 2004

(54) Combination voice coil and diaphragm device for receiver and its fabrication method

(75) Inventor: Lu-Lee Liao, Taichung (TW)

Correspondence Address: BROWDY AND NEIMARK, P.L.L.C., 624 NINTH STREET, NW, SUITE 300, WASHINGTON, DC, 20001-5303, US

(73) Assignee: Merry Electronics Co., Ltd., Taichung (TW)

(21) Appl. No.: 10/347,464

(22) Filed: Jan. 21, 2003

(51) Int. Cl. H04R 1/00; H04R 9/06; H04R 11/02

(52) U.S. Cl. 381/400; 381/407

(57) ABSTRACT

A combination voice coil and diaphragm device for use in a receiver is disclosed having a diaphragm injection-molded from plastics, and a voice coil formed integral with the diaphragm by means of thin film plating. The voice coil has electrodes integral with the diaphragm and extended to the periphery of the diaphragm for quick installation in the receiver.

### BACKGROUND OF THE INVENTION

1. Field of the Invention

The present invention relates to a receiver for communication and, more specifically, to a combination voice coil and diaphragm device for receiver and its fabrication method.

2. Description of the Related Art

A conventional receiver comprises an energy converting mechanism formed of a magnet, a plate electrode, a voice coil, and a diaphragm, and adapted for converting electric energy into sound. As shown in FIG. 1, when assembling a receiver, an enameled wire is wound round and round, forming a voice coil 90, and then the voice coil 90 is adhered to a diaphragm 91 or soldered to the peripheral frame of the diaphragm 91, and then the two lead ends of the voice coil 90 are respectively connected to a circuit board at a yoke by a respective lead wire, and then a cap and other parts are installed, forming the desired receiver. Because the voice coil is adhered or soldered to the diaphragm and then two lead wires are used to connect the two lead ends of the voice coil to the circuit board, much receiver installation space is needed for the voice coil and the diaphragm, resulting in bulk volume of the receiver. Because the arrangement of the lead wires complicates the installation of the voice coil and the diaphragm, thereby causing the voice coil and the diaphragm unable to be accurately set in position. If the voice coil and the diaphragm are not accurately set in position, the sound quality of the receiver will be affected. After installation, the lead wires and/or the voice coil tends to be broken and disconnected from the circuit board accidentally by an external force.

### SUMMARY OF THE INVENTION

The present invention has been accomplished to provide a combination voice coil and diaphragm device for a receiver, which eliminates the aforesaid drawbacks. It is one object of the present invention to provide a combination voice coil and diaphragm device for receiver and its fabrication method, which greatly reduces the dimensions of the receiver and improves the precision of the receiver.

It is another object of the present invention to provide a combination voice coil and diaphragm device for receiver and its fabrication method, which facilitates the assembly process of the receiver.

The combination voice coil and diaphragm device fabrication method includes the steps of (a) Material preparation, where plastic material is injection molded into a thin sheet of film having an outer diameter greater than the diaphragm to be made; (b) Thin sheet film processing: where electrically conductive polymeric material is coated on the thin sheet of film thus obtained at selected area, forming a connecting medium portion at the thin sheet of film; (c) Electroplating: where an electrically conductive metallic material is bonded to the connecting medium portion of the thin sheet of film by means of one of the techniques of metal thin film plating and printing; and (d) Die casting: where the thin sheet of film thus obtained is die-cast into a finished combination voice coil and diaphragm device having a diaphragm and a voice coil integral with the diaphragm.

### BRIEF DESCRIPTION OF THE DRAWINGS

FIG. 1 illustrates the arrangement of a voice coil and a diaphragm for a receiver according to the prior art.

FIG. 2 is a flow chart explaining a combination voice coil and diaphragm device fabrication method according to the present invention.

FIG. 3 is a sectional view showing a receiver constructed according to the present invention.

FIG. 4 is a sectional view in an enlarged scale of part A of FIG. 3.

FIG. 5 is a perspective view of an alternate form of the combination voice coil and diaphragm device according to the present invention.

### DETAILED DESCRIPTION OF THE INVENTION

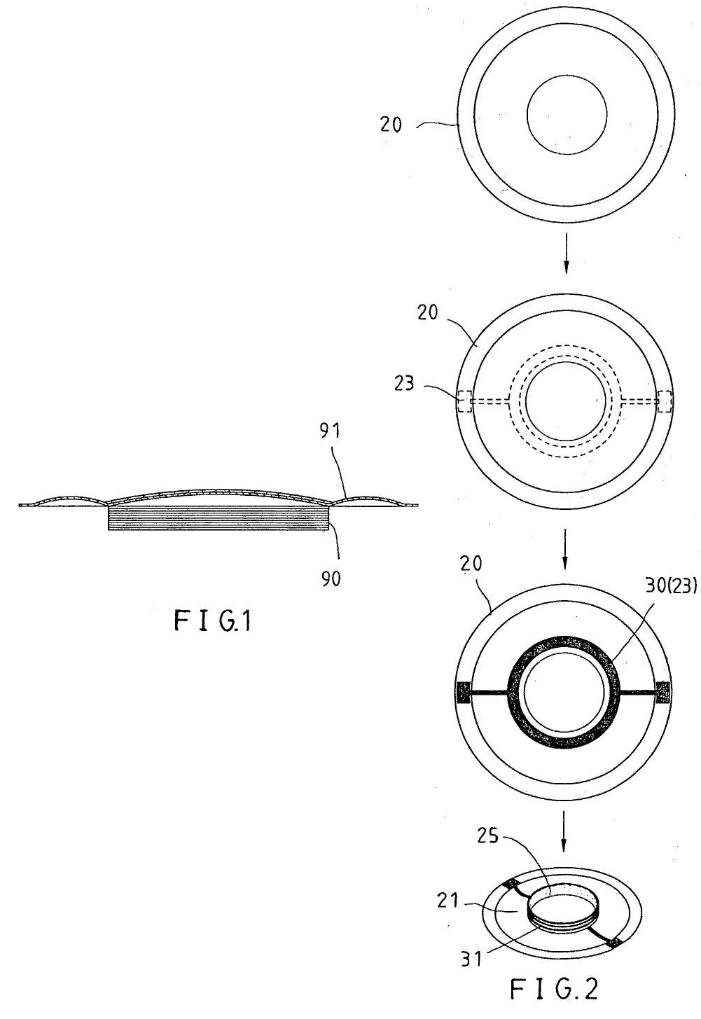

Referring to FIG. 2, a combination voice coil and diaphragm device fabrication method in accordance with the present invention includes the steps of:

a. Material preparation: where plastic material is injection molded into a thin sheet of film 20 having an outer diameter slightly greater than the desired diaphragm 21;

b. Thin sheet film processing: where electrically conductive polymeric material that is bondable to copper, aluminum or other metal alloy is coated on a particular area of the thin sheet of film 20, forming a connecting medium portion 23 at the thin sheet of film 20, which connecting medium portion 23 having two linear portions extended from the annular center portion to the periphery of the thin sheet of film 20 (see Step 2 in FIG. 2);

c. Electroplating: where an electrically conductive metallic material 30 is bonded to the connecting medium portion 23 by means of metal thin film plating technique or printing technique (see Step 3 in FIG. 2); and

d. Die casting: where the thin sheet of film 20 thus obtained is die-cast such that the connecting medium portion 23 forms an annular portion 25 so as to obtain the desired combination of a diaphragm 21 and a voice coil 31 integral with the diaphragm 21.

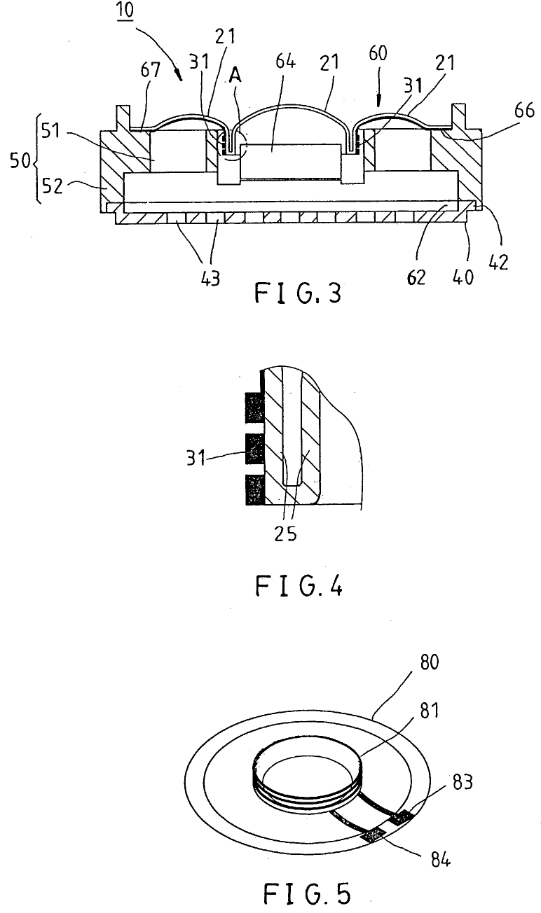

Referring to FIGS. 3 and 4, the invention is used in a receiver 10 (see FIG. 3). The receiver 10 comprises a bottom shell 40, the bottom shell 40 having a top coupling flange 42 extended around the periphery and a plurality of air vents 43 through the top and bottom sides, a holder frame 50, the holder frame 50 comprised of a yoke iron 51 and a frame base 52 injection-molded on the yoke iron 51, and an energy converting unit 60 mounted in the holder frame 50 and adapted to convert electric energy into sound. The energy-converting unit 60 is comprised of a diaphragm 21, a cushion pad 62, a voice coil 31, and a magnet 64. Because the receiver 10 is of the know art and not within the scope of the present invention, it is not necessary to describe the structure and functioning of the receiver 10 in detail. The main feature of the present invention is the combination design of the diaphragm 21 and the voice coil 31. The diaphragm 21 is provided with an annular portion 25. The voice coil 31 is formed integral with the diaphragm 21 by means of metal thin film plating technique or printing technique on the periphery of the annular portion 65 (see FIG. 4). The positive and negative electrodes 66 and 67 of the voice coil 63 are disposed at two sides of the periphery of the diaphragm 21 for connection to the power circuit. Therefore, no additional lead wires are needed to connect the voice coil 31 to the power circuit.

FIG. 5 shows an alternate form of the combination voice coil and diaphragm device. The combination voice coil and diaphragm device comprises a diaphragm 80, and a voice coil 81 integral with the diaphragm 80. The positive and negative electrodes 83 and 84 of the voice coil 81 are arranged in parallel and extended to the periphery of the diaphragm 80 in the same direction.

As indicated above, the combination voice coil and diaphragm device for receiver achieves the following advantages:

1. The combination voice coil and diaphragm device improves the stability and precision of the receiver and, greatly reduces the installation space of the receiver, fitting the requirement for a light, thin, short design.

2. The arrangement of the electrodes of the voice coil makes the installation of the power circuit easy without welding.

3. The combination design of the combination voice coil and diaphragm device simplifies the fabrication of the receiver.

What is claimed is:

1. A combination voice coil and diaphragm device fabrication method comprising the steps of:
(a) forming a thin sheet of film made of plastic material and having an outer diameter greater than the diaphragm to be made by injection molding;
(b) coating an electrically conductive polymeric material on the thin sheet to form a connecting medium portion at said thin sheet of film;
(c) bonding an electrically conductive metallic material to the connecting medium portion of the thin sheet of film by means of one of the techniques of metal thin film plating and printing to form a voice coil on said connecting medium portion;
(d) die-casting said thin sheet of film such that the connecting medium portion forms an annular portion on which the voice coil is bonded integrally.

2. The method as claimed in claim 1, wherein said electrically conductive polymeric material is a copper, aluminum, and metal alloy bondable material.

3. A combination of a voice coil and a diaphragm device comprising:
a diaphragm made of plastic materials by injection molding and having an annular portion; and
a voice coil bonded integrally on the annular portion by means of thin film plating or printing and made of electrically conductive metallic material.

4. The combination as claimed in claim 3, wherein said voice coil is made of copper.

5. The combination as claimed in claim 3, wherein said voice coil is made of aluminum.

6. The combination as claimed in claim 3, wherein said voice coil is made of a metal alloy.

7. The combination as claimed in claim 3, wherein said voice coil has two electrodes respectively extended from the ends thereof to the periphery of said diaphragm.

8. The combination as claimed in claim 3, wherein said voice coil is bonded to the periphery of said annular portion.
